(19) United States
(12) Patent Application Publication
(10) Pub. No.: US 2014/0085236 A1
(43) Pub. Date: Mar. 27, 2014

(54) Information Processing Method And Electronic Apparatus

(71) Applicants: Lenovo (Beijing) Co., Ltd., Beijing (CN); Beijing Lenovo Software Ltd., Beijing (CN)

(72) Inventors: Yongqiang Zhang, Beijing (CN); Ping Yang, Beijing (CN)

(73) Assignees: Lenovo (Beijing) Co., Ltd., Beijing (CN); Beijing Lenovo Software Ltd., Beijing (CN)

(21) Appl. No.: 14/033,678

(22) Filed: Sep. 23, 2013

(30) Foreign Application Priority Data
Sep. 21, 2012 (CN) CN 201210360656.5

(51) Int. Cl. G06F 3/041

(52) U.S. Cl. CPC G06F 3/0416
USPC 345/173

(57) ABSTRACT

An information processing method and an electronic apparatus are described. The electronic apparatus is provided with a touch sensing unit for acquiring a direction parameter of movement of the sense unit on the touch sensing unit when the sense unit is detected on the touch sensing unit; for acquiring a distance parameter of movement of the sense unit on the touch sensing unit; and generating an operation instruction based on the direction parameter and the distance parameter such that direction information for indicating direction of movement of an operation object on the touch sensing unit and distance information for indicating distance of the movement thereof are included in the operation instruction; and for executing the operation instruction to operate the operation object.

### BACKGROUND

This application claims priority to Chinese patent application No. 201210360656.5 filed Sep. 21, 2012, the entire contents of which are incorporated herein by reference.

The present invention relates to the field of computer technology, and particularly relates to an information processing method and an electronic apparatus.

With the development of the technology of electronic apparatus and the technology of touch control, the communication and interaction between the user and the electronic apparatus become more intuitive and more convenient, when game that needs to control direction and force at the same time in the electronic apparatus, such as game of archery type and game of billiard type is operated in touch control manner, the user's experience is better by controlling the direction with physical button or stick and controlling force with virtual slide bar.

However, the inventor of this application found that the above-described technology has at least the following technical problems in procedure of implementing the technical solution of the embodiment of this application:

Since the conventional electronic apparatus controls force by virtual slide bar, it results in the technical problem that the accuracy for controlling force is relatively low, so that the accuracy for controlling force by the user using the virtual slide bar is lowered, which causes the inconvenience of the usage of the user and a bad user's experience.

### SUMMARY

The embodiment of this application is for solving the technical problem that the accuracy for controlling force is relatively low when the electronic apparatus controls force with virtual slide bar and problem of the inconvenience of the usage of user and the bad user's experience caused thereby in the prior art by providing an information processing method and an electronic apparatus.

The embodiment of this application provides an information processing method applied in an electronic apparatus, the electronic apparatus is provided with a touch sensing unit, and the method includes:

Acquiring a direction parameter of movement of a sense unit on the touch sensing unit when the sense unit is detected on the touch sensing unit; and

Acquiring a distance parameter of the movement of the sense unit on the touch sensing unit;

Generating an operation instruction based on the direction parameter and the distance parameter, wherein, direction information for indicating movement direction of an operation object on the touch sensing unit and distance information for indicating movement distance thereof are included in the operation instruction;

Executing the operation instruction to operate the operation object.

Optionally, the acquiring the direction parameter of the movement of the sense unit on the touch sensing unit when the sense unit is detected on the touch sensing unit specifically includes: acquiring a first position parameter of the sense unit contacting the touch sensing unit when the sense unit is detected on the touch sensing unit; determining a fixed area of the touch sensing unit based on the first position; and acquiring the direction parameter of the movement of the sense unit in the fixed area of the touch sensing unit.

Optionally, the acquiring the direction parameter of the movement of the sense unit on the touch sensing unit when the sense unit is detected on the touch sensing unit specifically includes: deciding whether the sense unit is in a fixed area of the touch sensing unit based on a preset rule when the sense unit is detected on the touch sensing unit; and acquiring the direction parameter of the movement of the sense unit in the fixed area of the touch sensing unit when the sense unit is in the fixed area of the touch sensing unit.

Optionally, the deciding whether the sense unit is in the fixed area of the touch sensing unit based on a preset rule when the sense unit is detected on the touch sensing unit specifically includes: acquiring a second position parameter of the sense unit on the touch sensing unit when the sense unit is detected on the touch sensing unit; deciding whether the sense unit is in the fixed area of the touch sensing unit based on the second position parameter.

Optionally, the generating an operation instruction based on the direction parameter and the movement parameter wherein direction information for indicating the movement direction of an operation object on the touch sensing unit and distance information for indicating the movement distance thereof are included in the operation instruction specifically includes: determining the direction information of the movement direction of the operation object on the touch sensing unit based on the direction parameter; determining the distance information of the movement distance of the operation object based on the distance parameter; generating the operation instruction based on the direction information and the distance information.

Optionally, after executing the operation instruction to operate the operation object, the method further includes: acquiring a third position parameter of the sense unit on the touch sensing unit; deciding whether the third position parameter is the same as the first position parameter; adjusting the current position of the sense unit from a first position corresponding to the third position parameter to a second position corresponding to the first position parameter when the third position parameter is different from the first position parameter.

The embodiment of this application provides an electronic apparatus, the electronic apparatus is provided with touch sensing unit, and the electronic apparatus includes:

A circuit board;

A processing chip provided on the circuit board, for acquiring a direction parameter of movement of the sense unit on the touch sensing unit when the sense unit is detected on the touch sensing unit and for acquiring a distance parameter of movement of the sense unit on the touch sensing unit and generating an operation instruction based on the direction parameter and the distance parameter, wherein, direction information for indicating movement direction of an operation object on the touch sensing unit and distance information for indicating movement distance thereof are included in the operation instruction, and for executing the operation instruction to operate the operation object.

Optionally, the processing chip is provided with a first movement parameter obtaining unit for acquiring a first position parameter of the sense unit contacting the touch sensing unit when the sense unit is detected on the touch sensing unit and for determining a fixed area of the touch sensing unit based on the first position parameter and acquiring a direction parameter of movement of the sense unit in the fixed area of the touch sensing unit.

Optionally, the processing chip is provided with a second movement parameter obtaining unit for deciding whether the sense unit is in the fixed area of the touch sensing unit based on a preset rule when the sense unit is detected on the touch sensing unit and for acquiring a direction parameter of movement of the sense unit in the fixed area of the touch sensing unit when the sense unit is in the fixed area of the touch sensing unit.

Optionally, the second movement parameter obtaining unit is provided with a deciding unit for acquiring a second position parameter of the sense unit on the touch sensing unit when the sense unit is detected on the touch sensing unit, and for deciding whether the sense unit is in the fixed area of the touch sensing unit based on the second position parameter.

Optionally, the processing chip is provided with an instruction generating unit for determining direction information of movement direction of operation object on the touch sensing unit based on the direction parameter and for determining distance information of movement distance of the operation object based on the distance parameter and generating the operation instruction based on the direction information and the distance information.

Optionally, the processing chip is provided with a first position adjusting unit for, after executing the operation instruction to operate the operation object, acquiring a third position parameter of the sense unit on the touch sensing unit and deciding whether the third position parameter is the same as the first position parameter, adjusting the current position of the sense unit from a first position corresponding to the third position parameter to a second position corresponding to the first position parameter when the third position parameter is different from the first position parameter.

One or more technical solutions provided by the embodiment of this application at least have the following technical effects or advantages:

First, the embodiment of this application acquires a direction parameter and a distance parameter of movement of the sense unit on the touch sensing unit when the sense unit is detected on the touch sensing unit and generates an operation instruction including direction information indicating movement direction of an operation object on the touch sensing unit and distance information for indicating movement distance thereof based on the direction parameter and the distance parameter, and then executes the operation instruction to operate the operation object. Therefore, with this method, the electronic apparatus is made to control the direction information and the distance information of the movement of the corresponding operation object according to the direction parameter and the distance parameter of the movement of the sense unit on the touch sensing unit, it can increase the accuracy for controlling force and direction effectively, so that the user can control the force and the direction of the operation object more accurately, so as to facilitate the usage of the user and have a better user experience.

Second, the embodiment of this application acquires the third position parameter of the sense unit on the touch sensing unit and decides whether the third position parameter is the same as the first position parameter and adjusts the current position of the sense unit from the first position corresponding to the third position parameter to the second position corresponding to the first position parameter when the third position parameter is different from the first position parameter after executing the operation instruction to operate the operation object, i.e., automatic reset of the sense unit. Therefore, with this method, the direction parameter and the distance parameter of the movement of the sense unit on the touch sensing unit obtained by the electronic apparatus are made more accurate, so as to further increase the accuracy for controlling force and direction, so that the user can control the force and the direction of the operation object more accurately, so as to facilitate the usage of the user and have a better user experience.

### BRIEF DESCRIPTION OF THE DRAWINGS

FIG. 1 is a flow chart of the information processing method in the first embodiment of this application;

FIG. 2 is a structural diagram of the sense unit on the touch sensing unit in the first embodiment of this application;

FIG. 3 is a structural diagram of the movement of the sense unit in the fixed area in the first embodiment of this application;

FIG. 4 is a structural diagram of controlling the movement of billiard according to FIG. 3 in the first embodiment of this application;

FIG. 5 is a flow chart of the information processing method in the second embodiment of this application;

FIG. 6 is a structural diagram of the sense unit on the touch sensing unit in the second embodiment of this application;

FIG. 7 is a structural schematic diagram of the electronic apparatus in the first embodiment of this application;

FIG. 8 is a structural schematic diagram of the electronic apparatus in the second embodiment of this application.

### DETAILED DESCRIPTION

The embodiment of this application is for solving the technical problem that the accuracy for controlling force is relatively low when the electronic apparatus controls force with virtual slide bar and problem of the inconvenience of the usage of user and the bad user's experience caused thereby in the prior art by providing an information processing method and an electronic apparatus.

The technical solution of the embodiment of this application has an overall concept for solving the above-described problem of inconvenience in the usage of the user as follows:

A direction parameter and a distance parameter of movement of the sense unit on the touch sensing unit are acquired when the sense unit is detected on the touch sensing unit and an operation instruction including direction information indicating movement direction of operation object on the touch sensing unit and distance information for indicating movement distance thereof are generated based on the direction parameter and the distance parameter, and then the operation instruction is executed to operate the operation object. Therefore, with this method, the electronic apparatus is made to control the distance information of the movement of the corresponding operation object according to the distance parameter of the movement of the sense unit on the touch sensing unit, it can increase the accuracy for controlling force effectively, so that the user can control the force of the operation object more accurately, so as to facilitate the usage of the user and have a better user experience.

For understanding the above-described technical solution better, the above-described technical solution is explained in detail in combination with the accompanying drawings of the specification and the specific implementation mode.

The present invention provides an information processing method applied in an electronic apparatus, the electronic apparatus is provided with a touch sensing unit and is for example mobile phone, tablet computer, laptop or the like, the touch sensing unit is an electronic apparatus such as resistance-type touch screen, capacitance-type touch screen or the like.

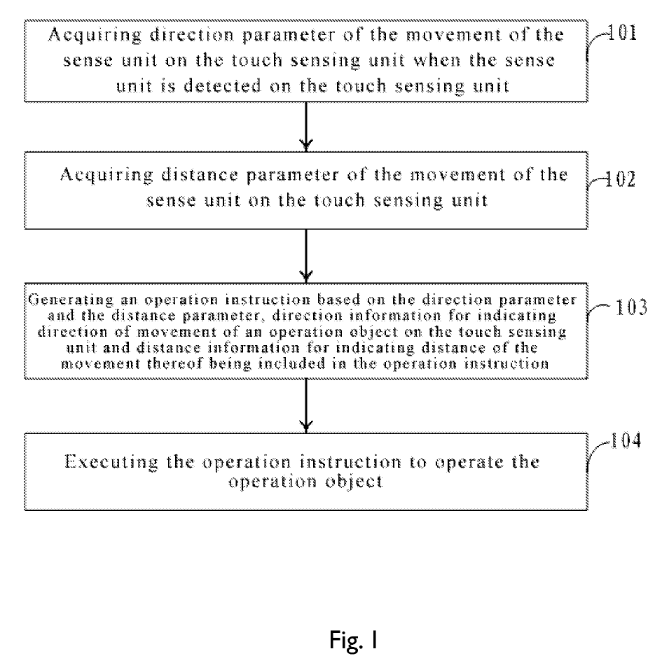

As shown in FIG. 1, the method includes:

Step 101: acquiring a direction parameter of movement of a sense unit on the touch sensing unit when the sense unit is detected on the touch sensing unit;

Step 102: acquiring a distance parameter of the movement of the sense unit on the touch sensing unit;

Step 103: generating an operation instruction based on the direction parameter and the distance parameter, wherein, direction information for indicating direction of the movement of an operation object on the touch sensing unit and distance information for indicating distance of the movement thereof are included in the operation instruction;

Step 104: executing the operation instruction to operate the operation object.

Wherein, the sense unit is for example an entity device such as stick or the like provided with a conductive element.

Wherein, in step 101, whether there is the sense unit on the touch sensing unit is detected firstly, in the specific implementation procedure, when the touch sensing unit is provided with the sense unit, the touch sensing unit can receive specific information for representing the sense unit being provided on the touch sensing unit, the specific information is for example a control instruction or a piece of short code; of course, a first parameter of the sense unit can be stored in the electronic apparatus in advance, whether a second parameter acquired through touch sense is same as the first parameter is decided, and when a second parameter that is same as the first parameter is detected, it confirms that the sense unit is provided on the touch sensing unit.

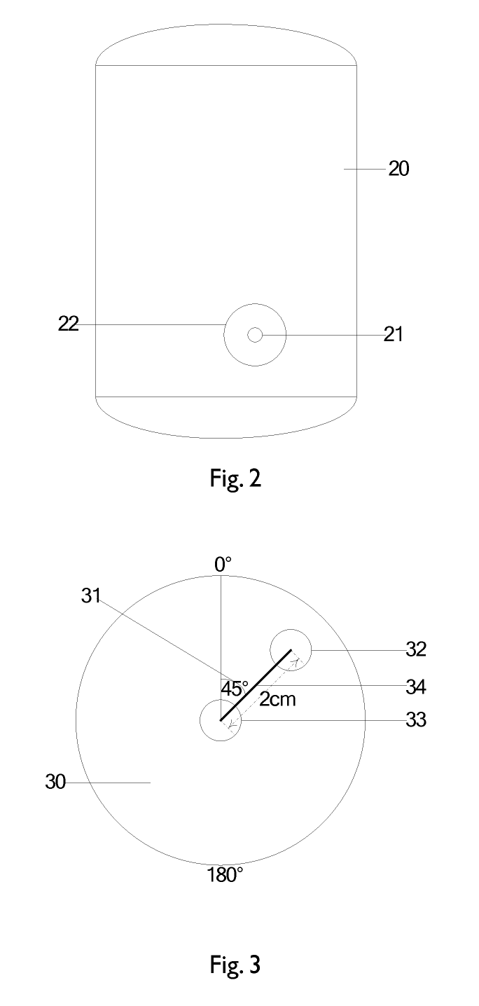

In particular, when the sense unit is detected on the touch sensing unit, a first position parameter of the sense unit contacting the touch sensing unit is acquired, and a fixed area of the touch sensing unit is determined based on the first position parameter, and the direction parameter of the movement of the sense unit in the fixed area of the touch sensing unit is acquired. In the specific implementation procedure, once the sense unit contacts the touch sensing unit, the position of the sense unit with respect to the touch sensing unit is fixed, the touch sensing unit receives a parameter from the touch sensing unit to analyze, thus can determine the first position parameter of the sense unit contacting the touch sensing unit, and a fixed area is laid out on the touch sensing unit so as to make the sense unit move in the fixed area, and the direction parameter of the movement of the sense unit in the fixed area is acquired. For example, as shown in FIG. 2, the touch screen 20 can decide whether there is a sense unit 21 contacting with the touch screen 20 according to the obtained information, and when the sense unit 21 contacts with the touch screen 20, the fixed area 22 is determined according to the contacting position of the sense unit 21 with the touch screen 20, the sense unit 21 can move in the fixed area 22, and when the sense unit 21 moves in the fixed area 22, the direction parameter of the movement of the sense unit 21 is acquired.

Wherein, in step 101, the direction parameter of the movement of the sense unit on the touch sensing unit is acquired, in the specific implementation procedure, a first position parameter of the sense unit contacting with the touch sensing unit is acquired, and a fourth position parameter of the sense unit contacting with the touch sensing unit is acquired when the movement of the sense unit is detected, the direction parameter of the movement of the sense unit on the touch sensing unit is acquired based on the first position parameter and the fourth position parameter. For example, as shown in FIG. 3, the fixed area 30 is divided into 0-360 degree, and the acquired direction parameter of the movement is 45 degree according to the sense unit 33 in the first position parameter and the sense unit 32 moved to the fourth position parameter in the fixed area 30.

Wherein, step 101 and step 102 do not have a certain order, this example takes step 101 being executed firstly as example, but in the practical implementation, step 102 can be executed firstly, and step 101 and step 102 can be executed at the same time.

Step 102 is executed next and, in this step, the distance parameter of the movement of the sense unit on the touch sensing unit can be acquired based on the acquired first position parameter and the fourth position parameter of the sense unit when the direction parameter is acquired according to step 101. For example, as shown in FIG. 3, when the sense unit 33 in the first position parameter moves to the sense unit 32 in the fourth position parameter, the acquired distance parameter 34 is 2 cm.

Step 103 is executed next, in this step, the direction information of the direction of movement of an operation object on the touch sensing unit is determined; the distance information of the distance within which the operation object moves is determined based on the distance parameter, and an operation instruction is generated based on the direction information and the distance information. In the specific implementation procedure, the direction parameter of the sense unit is matched with the direction parameter of the operation object the touch sensing unit operates currently, the direction parameter of the movement of the sense unit on the touch sensing unit corresponds to the direction information of the movement of the operation object, for example, if the direction parameter of the movement of the sense unit is 0 degree, the arrow is shot to the left direction in the horizontal direction in an archery game, thus, the direction in which the operation object moves can be controlled by the direction parameter of the movement of the sense unit.

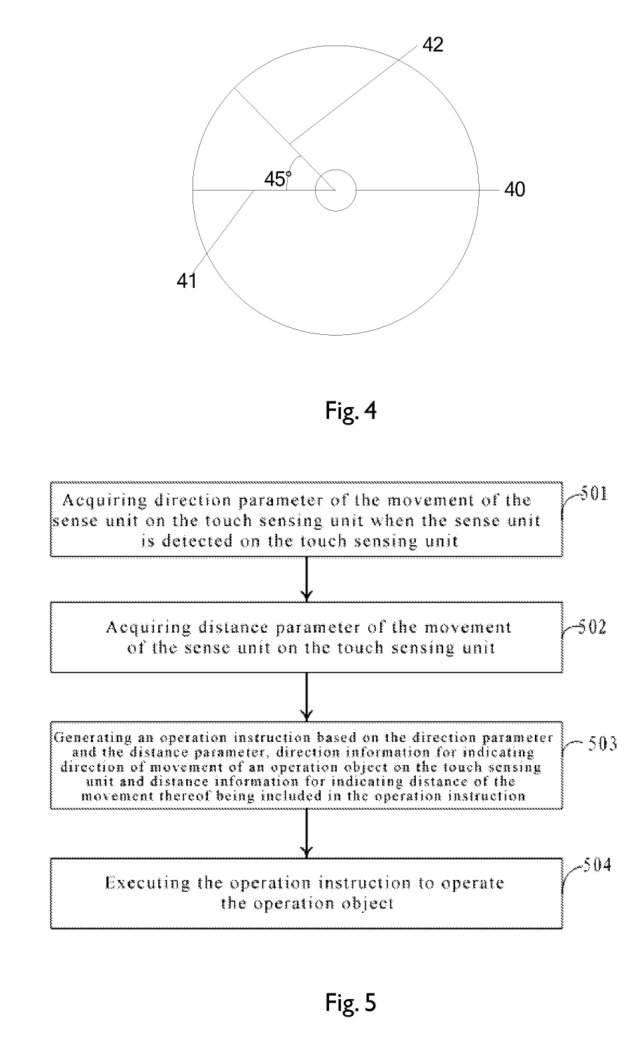

In particular, as shown in FIG. 4, for example, as in the billiard game, the direction of the billiard 40 moving leftwards is as an origin 41 corresponding to the direction parameter 0 degree of the sense unit in FIG. 3, and the direction of the billiard 40 rotating clockwise from the origin 41 corresponds to the 0-360 degree of the sense unit in FIG. 3 respectively, thus, the direction parameter 45 degree of the sense unit in FIG. 3 corresponds to the first direction 42 rotating clockwise by 45 degree from the origin 41 in FIG. 4, that is, the billiard 40 moves in the first direction 42.

Wherein, in step 103, the distance parameter that the sense unit moves is matched with the distance information that the operation object moves in term of functions, for example, every centimeter the sense unit moves, the operation object moves by 20 centimeters, the force required by the operation object moving by 20 centimeters can be calculated by a force conversion formula. For example, it assumes the maximum distance of the arrow shot is 250 meters in the archery game, the distance 0-250 meters of the archery is converted to required force 0-100% proportionally, that is, when the force utilized is 100%, the arrow can be shot to position of 250 meters, and the sense unit can move up to a maximum distance of 10 cm, the distance 0-10 cm that the sense unit moves is corresponding to the force 0-100% one by one, thus, the force required by archery and the distance parameter that the arrow can move are calculated by the distance that the sense unit moves. Thus, the electronic apparatus is made to increase the control to the accuracy of the force, so that the user can obtain the distance parameter that the sense unit moves to control the force of the operation object, the user is brought a more intuitive feeling, and it can facilitate the usage of the user and has a better user experience.

Step 104 is executed next, in this step, since the operation instruction generated in step 103 includes direction information for indicating direction of movement of the operation object on the touch sensing unit and distance information for indicating distance of the movement thereof, the operation instruction is executed to operate the operation object based on the direction information and the distance information. In the specific implementation procedure, for example, the direction parameter of the movement of the sense unit is 45 degree, the direction information of the archery corresponding to the direction parameter 45 degree is a horizontal direction leftwards, and the distance parameter of the movement of the sense unit is 2 cm, and the distance information corresponding to 2 cm is force of 20%, the arrow is shot with force of 20% leftwards in horizontal direction when the operation instruction is executed.

Secondly, after executing the operation instruction to operate the operation object, that is, after the sense unit is automatically reset, a third position parameter of the sense unit on the touch sensing unit is acquired and whether the third position parameter is the same as the first position parameter is decided, the current position of the sense unit is adjusted from a first position corresponding to the third position parameter to a second position corresponding to the first position parameter when the third position parameter is different from the first position parameter. Wherein, the sense unit can be automatically reset to the second position, or the electronic apparatus send a control instruction to the sense unit to control the sense unit to return to the second position.

In the specific implementation procedure, as shown in FIG. 3, after executing the operation instruction, the sense unit 32 in a fourth position is automatically reset to the sense unit 33 in the first position parameter, and after the sense unit completing the automatic reset, for further ensuring the accuracy of the next movement of the sense unit, it needs to acquire a third position parameter of the sense unit contacting with the touch sensing unit, and decide whether the third position parameter is same as the first position parameter, and when they are different, the current position of the sense unit is adjusted from the first position corresponding to the third position parameter to the sense unit 33 in the first position parameter. Thus, the accuracy of the sense unit can be increased further, so as to provide convenience to the user and has a better user experience.

The present invention provides an information processing method applied in an electronic apparatus, the electronic apparatus is provided with a touch sensing unit and is for example mobile phone, tablet computer, laptop or the like, the touch sensing unit is an electronic apparatus such as resistance-type touch screen, capacitance-type touch screen or the like.

As shown in FIG. 5, the method includes:

Step 501: acquiring a direction parameter of movement of a sense unit on the touch sensing unit when the sense unit is detected on the touch sensing unit;

Step 502: acquiring a distance parameter of the movement of the sense unit on the touch sensing unit;

Step 503: generating an operation instruction based on the direction parameter and the distance parameter, wherein, direction information for indicating direction of the movement of an operation object on the touch sensing unit and distance information for indicating distance of the movement thereof are included in the operation instruction;

Step 504: executing the operation instruction to operate the operation object.

Wherein, the sense unit is for example an entity device such as stick or the like provided with a conductive element.

Wherein, in step 501, when the sense unit is detected on the touch sensing unit, whether the sense unit is in a fixed area of the touch sensing unit is decided based on a preset rule; the direction parameter of the movement of the sense unit in the fixed area of the touch sensing unit is acquired when the sense unit is in the fixed area of the touch sensing unit. In specific implementation procedure, when the sense unit is detected on the touch sensing unit, a second position parameter of the sense unit on the touch sensing unit is acquired; whether the sense unit is in the fixed area of the touch sensing unit is decided based on the second position parameter.

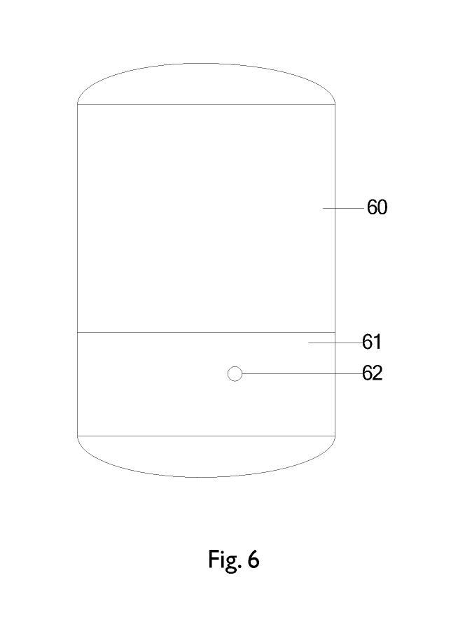

In particular, the touch sensing unit is provided with a fixed area, a fifth position parameter of the fixed area is acquired, when the sense unit contacts with the touch sensing unit, the second position parameter of the sense unit on the touch sensing unit is acquired, whether the second position parameter is within the fifth position parameter is decided, when the second position parameter is within the fifth position parameter, the direction parameter of the movement of the sense unit in the fixed area is acquired. For example, as shown in FIG. 6, a fixed area 61 is provided on the touch screen 60, when the sense unit 62 is in the fixed area 61, the direction parameter of the movement of the sense unit in the fixed area 61 is acquired.

Wherein, step 501 and step 502 do not have a certain order, this example takes step 501 being executed firstly as example, but in the practical implementation, step 502 can be executed firstly, and step 501 and step 502 can be executed at the same time.

Step 502 is executed next, in this step, the distance parameter of the movement of the sense unit on the touch sensing unit can be acquired based on the acquired second position parameter of the sense unit and a fourth position parameter of the sense unit contacting with the touch sensing unit acquired when the sense unit moves in the fixed area when the direction parameter is acquired according to step 501.

Step 503 is executed next, in this step, the direction information of the direction of movement of an operation object on the touch sensing unit is determined; the distance information of the distance of the movement of the operation object is determined based on the distance parameter, and an operation instruction is generated based on the direction information and the distance information. In the specific implementation procedure, the direction parameter of the sense unit is matched with the direction parameter of the operation object that the touch sensing unit operates currently, the direction parameter of the movement of the sense unit on the touch sensing unit corresponds to the direction information of the movement of the operation object, for example, if the direction parameter of the movement of the sense unit is 0 degree, the arrow is shot leftwards in horizontal direction in the archery game. Thus, the electronic apparatus is made to increase the control to the accuracy of the force, so that the user can obtain the distance parameter that the sense unit moves to control the force of the operation object, the user is brought a more intuitive feeling, and it can facilitate the usage of the user and has a better user experience.

Step 504 is executed next, in this step, since the operation instruction generated in step 503 includes direction information for indicating direction of movement of the operation object on the touch sensing unit and distance information for indicating distance of the movement thereof, the operation instruction is executed to operate the operation object based on the direction information and the distance information.

Secondly, after executing the operation instruction to operate the operation object, that is, after the sense unit is automatically reset, a third position parameter of the sense unit on the touch sensing unit is acquired and whether the third position parameter is the same as the second position parameter is decided, the sense unit is adjusted from a first position corresponding to the third position parameter to a third position corresponding to the second position parameter when the third position parameter is different from the second position parameter. Wherein, the sense unit can be automatically reset to the third position, or the electronic apparatus send a control instruction to the sense unit to control the sense unit return to the third position. Thus, the accuracy of the sense unit can be increased further, so as to provide convenience to the user and has a better user experience.

The present invention further provides an electronic apparatus, the electronic apparatus is provided with a touch sensing unit and is for example mobile phone, tablet computer, laptop or the like, the touch sensing unit is an electronic apparatus such as resistance-type touch screen, capacitance-type touch screen or the like.

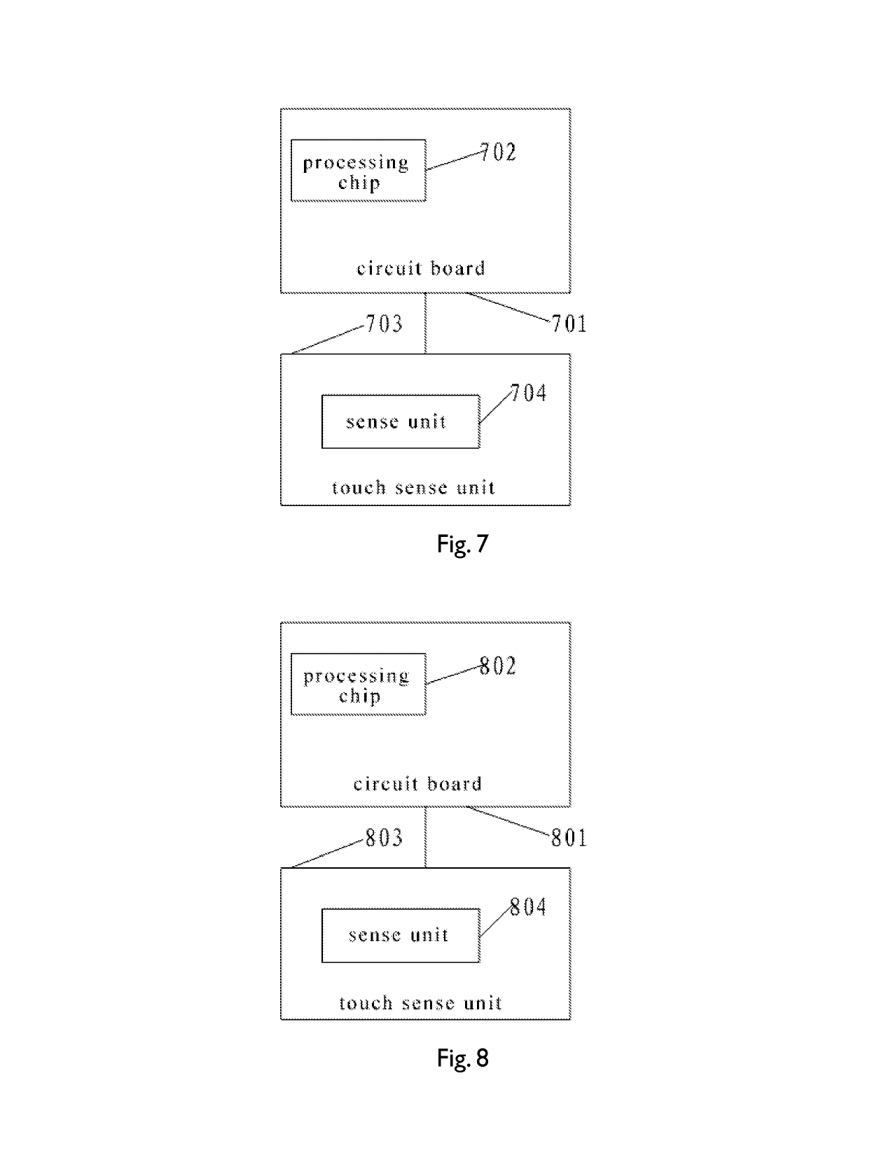

Referring to FIG. 7, the electronic apparatus includes: a circuit board 701; a processing chip 702 provided on the circuit board 701, for acquiring a direction parameter of movement of the sense unit 704 on the touch sensing unit 703 when the sense unit 704 is detected on the touch sensing unit 703 and for acquiring a distance parameter of movement of the sense unit 704 on the touch sensing unit 703 and generating an operation instruction based on the direction parameter and the distance parameter, wherein, direction information for indicating direction of movement of an operation object on the touch sensing unit 703 and distance information for indicating distance of the movement thereof are included in the operation instruction, and for executing the operation instruction to operate the operation object.

Wherein, the circuit board 701 can be a mainboard of the electronic apparatus, further, the processing chip 702 may be an independent processing chip, and may be integrated into a processor.

Further, the sense unit 704 may be an entity stick provided with a conductive unit and be capable of data transmission with the touch sensing unit 703.

Further, the processing chip 702 is provided with a first movement parameter obtaining unit for acquiring a first position parameter of the sense unit contacting the touch sensing unit when the sense unit is detected on the touch sensing unit and for determining a fixed area of the touch sensing unit based on the first position parameter and acquiring a direction parameter of movement of the sense unit in the fixed area of the touch sensing unit.

Further, the processing chip 702 is provided with an instruction generating unit for determining direction information of direction of the movement of the operation object on the touch sensing unit based on the direction parameter and for determining distance information of distance of the movement of the operation object based on the distance parameter and generating the operation instruction based on the direction information and the distance information.

Further, the processing chip 702 is provided with a first position adjusting unit for, after executing the operation instruction to operate the operation object, acquiring a third position parameter of the sense unit on the touch sensing unit and deciding whether the third position parameter is the same as the first position parameter, adjusting the current position of the sense unit from a first position corresponding to the third position parameter to a second position corresponding to the first position parameter when the third position parameter is different from the first position parameter.

In an embodiment, when the sense unit 704 contacts with the touch sensing unit 703, the processing chip 702 can acquire a first position parameter of the sense unit 704 contacting with the touch sensing unit 703 from the touch sensing unit 703, acquire a fourth position parameter of the sense unit 704 on the touch sensing unit 703 when the sense unit 704 moves on the touch sensing unit 703, and can obtain a direction parameter and a distance parameter of the movement of the sense unit 704 on the touch sensing unit 703 based on the first position parameter and the fourth position parameter, and obtain direction information and distance information corresponding to the current operation object of the touch sensing unit 703 according to corresponding relation and function preset in the processing chip 702, the direction information and the distance information are set in the control instruction to be executed, so as to make the user control the movement of the operation object by controlling the movement of the sense unit 704, which bring more intuitive feeling to the user, thus facilitate the usage of user and has a better user experience.

The modified manners and specific example in the information processing method of the above-mentioned embodiment in FIG. 1 can be applied in the electronic apparatus of the present embodiment likewise, and those skilled in the art can understand the implementing method of the electronic apparatus in the present embodiment by the detailed description of the above information processing method, thus it is no longer described for the simplicity of the specification.

Another aspect of the present invention further provides an electronic apparatus, the electronic apparatus is provided with a touch sensing unit and is for example mobile phone, tablet computer, laptop or the like, the touch sensing unit is an electronic apparatus such as resistance-type touch screen, capacitance-type touch screen or the like.

Referring to FIG. 8, the electronic apparatus includes: a circuit board 801; a processing chip 802 provided on the circuit board 801, for acquiring a direction parameter of movement of the sense unit 804 on the touch sensing unit 803 when the sense unit 804 is detected on the touch sensing unit 803 and for acquiring a distance parameter of movement of the sense unit 804 on the touch sensing unit 803 and generating an operation instruction based on the direction parameter and the distance parameter, wherein, direction information for indicating direction of movement of an operation object on the touch sensing unit 803 and distance information for indicating distance of the movement thereof are included in the operation instruction, and for executing the operation instruction to operate the operation object.

Wherein, the circuit board 801 can be mainboard of the electronic apparatus, further, the processing chip 802 may be independent processing chip, and may be integrated into a processor.

Further, the sense unit 804 may be an entity stick provided with conductive unit and be capable of data transmission with the touch sensing unit 803.

Further, the processing chip 802 is provided with a second movement parameter obtaining unit for deciding whether the sense unit is in the fixed area of the touch sensing unit based on a preset rule when the sense unit is detected on the touch sensing unit and for acquiring a direction parameter of movement of the sense unit in the fixed area of the touch sensing unit when the sense unit is in the fixed area of the touch sensing unit.

Further, the second movement parameter obtaining unit is provided with a deciding unit for acquiring a second position parameter of the sense unit on the touch sensing unit when the sense unit is detected on the touch sensing unit, and for deciding whether the sense unit is in the fixed area of the touch sensing unit based on the second position parameter.

Further, the processing chip 802 is provided with an instruction generating unit for determining direction information of direction of the movement of the operation object on the touch sensing unit based on the direction parameter and for determining distance information of distance of the movement of the operation object based on the distance parameter and generating the operation instruction based on the direction information and the distance information.

Further, the processing chip 802 is provided with a second position adjusting unit for; after executing the operation instruction to operate the operation object; acquiring a third position parameter of the sense unit on the touch sensing unit and deciding whether the third position parameter is the same as the second position parameter; adjusting the sense unit from a first position corresponding to the third position parameter to a third position corresponding to the second position parameter when the third position parameter is different from the second position parameter.

The modified manners and specific example in the information processing method in the above-mentioned embodiment in FIG. 5 can be applied in the electronic apparatus in the present embodiment likewise, and those skilled in the art can understand the implementing method in the electronic apparatus in the present embodiment by the detailed description in the above information processing method, thus it is no longer described for the simplicity of specification.

The technical solution in the above-described embodiment of the present application at least has the following technical effects or advantages:

First, the embodiment of this application acquires a direction parameter and distance parameter of movement of the sense unit on the touch sensing unit when the sense unit is detected on the touch sensing unit and generates an operation instruction including direction information indicating movement direction of operation object on the touch sensing unit and distance information for indicating movement distance thereof based on the direction parameter and the distance parameter, and then executes the operation instruction to operate the operation object. Therefore, with this method, the electronic apparatus is made to control the direction information and the distance information of the movement of the corresponding operation object according to the direction parameter and the distance parameter of the movement of the sense unit on the touch sensing unit, it can increase the accuracy for controlling force and direction effectively, so that the user can control the force and the direction of the operation object more accurately, so as to facilitate the usage of the user and have a better user experience.

Second, the embodiment of this application acquires the third position parameter of the sense unit on the touch sensing unit and decides whether the third position parameter is the same as the first position parameter and adjusts the current position of the sense unit from the first position corresponding to the third position parameter to the second position corresponding to the first position parameter when the third position parameter is different from the first position parameter after executing the operation instruction to operate the operation object, i.e., automatic reset of the sense unit. Therefore, with this method, the direction parameter and the distance parameter of the movement of the sense unit on the touch sensing unit obtained by the electronic apparatus is made more accurate, so as to further increase the accuracy for controlling force and direction, so that the user can control the force and the direction of the operation object more accurately, so as to facilitate the usage of the user and have a better user experience.

Though the preferred embodiments of the present invention are described, those skilled in the art can make additional alteration and modification to these embodiments in case of knowing the basic creative concept. Therefore, the appended claims intend to be defined as including the preferable embodiments as well as all of the alterations and modifications fallen into the scope of the present invention.

It is obvious that those skilled in the art can make any modification and variation to the present invention without departing from the spirit and scope of the present invention.

Thus, if these modifications and variations of the present invention fall within the scope of the claims of the present invention and the equivalent technology, the present invention intends to comprise these modifications and variations.

1. An information processing method applied in an electronic apparatus, the electronic apparatus being provided with a touch sensing unit, the method including:
acquiring a direction parameter of movement of a sense unit on the touch sensing unit when the sense unit is detected on the touch sensing unit;
acquiring a distance parameter of the movement of the sense unit on the touch sensing unit;
generating an operation instruction based on the direction parameter and the distance parameter, wherein, direction information for indicating direction of movement of an operation object on the touch sensing unit and distance information for indicating distance of the movement thereof are included in the operation instruction; and,
executing the operation instruction to operate the operation object.

2. The method according to claim 1, wherein, the acquiring the direction parameter of the movement of the sense unit on the touch sensing unit when the sense unit is detected on the touch sensing unit includes:
acquiring a first position parameter of the sense unit contacting with the touch sensing unit when the sense unit is detected on the touch sensing unit; and,
determining a fixed area of the touch sensing unit based on the first position parameter, and acquiring the direction parameter of the movement of the sense unit in the fixed area of the touch sensing unit.

3. The method according to claim 1, wherein, the acquiring the direction parameter of the movement of the sense unit on the touch sensing unit when the sense unit is detected on the touch sensing unit includes:
deciding whether the sense unit is in the fixed area of the touch sensing unit based on a preset rule when the sense unit is detected on the touch sensing unit; and,
acquiring the direction parameter of the movement of the sense unit in the fixed area of the touch sensing unit when the sense unit is in the fixed area of the touch sensing unit.

4. The method according to claim 3, wherein, the deciding whether the sense unit is in the fixed area of the touch sensing unit based on a preset rule when the sense unit is detected on the touch sensing unit includes:
acquiring a second position parameter of the sense unit on the touch sensing unit when the sense unit is detected on the touch sensing unit; and,
deciding whether the sense unit is in the fixed area of the touch sensing unit based on the second position parameter.

5. The method according to claim 1, wherein, the generating an operation instruction based on the direction parameter and the movement parameter wherein, direction information for indicating the direction of the movement of the operation object on the touch sensing unit and distance information for indicating the distance of the movement thereof are included in the operation instruction includes:
determining the direction information of the direction of the movement of the operation object on the touch sensing unit based on the direction parameter;
determining the distance information of the distance of the movement of the operation object based on the distance parameter; and,
generating the operation instruction based on the direction information and the distance information.

6. The method according to claim 2, wherein, after executing the operation instruction to operate the operation object, the method further includes:
acquiring a third position parameter of the sense unit on the touch sensing unit;
deciding whether the third position parameter is same as the first position parameter; and,
adjusting a current position of the sense unit from a first position corresponding to the third position parameter to a second position corresponding to the first position parameter when the third position parameter is different from the first position parameter.

7. An electronic apparatus provided with a touch sensing unit, the electronic apparatus comprising:
a circuit board; and,
a processing chip provided on the circuit board, for acquiring a direction parameter of movement of the sense unit on the touch sensing unit when the sense unit is detected on the touch sensing unit and for acquiring a distance parameter of movement of the sense unit on the touch sensing unit and generating an operation instruction based on the direction parameter and the distance parameter, wherein, direction information for indicating direction of movement of an operation object on the touch sensing unit and distance information for indicating distance of the movement thereof are included in the operation instruction, and for executing the operation instruction to operate the operation object.

8. The electronic apparatus according to claim 7, wherein, the processing chip is provided with a first movement parameter obtaining unit for acquiring a first position parameter of the sense unit contacting with the touch sensing unit when the sense unit is detected on the touch sensing unit and for determining a fixed area of the touch sensing unit based on the first position parameter and acquiring a direction parameter of movement of the sense unit in the fixed area of the touch sensing unit.

9. The electronic apparatus according to claim 7, wherein, the processing chip is provided with a second movement parameter obtaining unit for deciding whether the sense unit is in the fixed area of the touch sensing unit based on a preset rule when the sense unit is detected on the touch sensing unit and for acquiring a direction parameter of movement of the sense unit in the fixed area of the touch sensing unit when the sense unit is in the fixed area of the touch sensing unit.

10. The electronic apparatus according to claim 9, wherein, the second movement parameter obtaining unit is provided with a deciding unit for acquiring a second position parameter of the sense unit on the touch sensing unit when the sense unit is detected on the touch sensing unit and for deciding whether the sense unit is in the fixed area of the touch sensing unit based on the second position parameter.

11. The electronic apparatus according to claim 7, wherein, the processing chip is provided with an instruction generating unit for determining direction information of direction of the movement of the operation object on the touch sensing unit based on the direction parameter and for determining distance information of distance of the movement of the operation object based on the distance parameter and generating the operation instruction based on the direction information and the distance information.

12. The electronic apparatus according to claim 7, wherein, the processing chip is provided with a first position adjusting unit for, after executing the operation instruction to operate the operation object, acquiring a third position parameter of the sense unit on the touch sensing unit and deciding whether the third position parameter is the same as the first position parameter, adjusting the current position of the sense unit from a first position corresponding to the third position parameter to a second position corresponding to the first position parameter when the third position parameter is different from the first position parameter.
